(19) United States
(12) Patent Application Publication
(10) Pub. No.: US 2006/0253455 A1
(43) Pub. Date: Nov. 9, 2006

(54) Extensible type-based publication / subscription services

(75) Inventors: Adrian Potra, Issaquah, WA (US); Krishnamurthy Ganesan, Redmond, WA (US); Mu Han, Redmond, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/123,741

(22) Filed: May 5, 2005

(51) Int. Cl. G06F 17/30

(52) U.S. Cl. 707/10

(57) ABSTRACT

Technology to facilitate collaborative communications is provided. The technology may include, for example, operations directed to publishing and subscribing services. The operations may facilitate publication of data derived from multiple data types as well as subscription to selectively filtered views of published data. Published data may be updated, and notification of various events and services may be provided.

### BACKGROUND OF THE TECHNOLOGY

1. Field of the Technology

The technology relates to information processing. More particularly, the technology relates to collaborative information activities and applications, including those associated with a networked environment.

2. Description of Related Art

Real time collaboration platforms generally facilitate communication between two or more entities in a networked environment. The communication may comprise a variety of entities and activities. For example, simple sessions may provide means for one entity to ascertain the presence of another entity. More complex collaborative sessions may involve, for example, instant messaging, audio/video, and other activities between multiple entities.

Given the widespread use and popularity of such collaboration platforms, it is often useful for an application to publish various types of information and for such information to be available by subscription to remote applications. It is further useful for remote applications to receive timely notifications whenever the published information changes.

Unfortunately, current collaboration platforms typically limit applications to publications of predefined and restricted sets of data and limit remote applications to receipt of original, published information, rendering collaborative activities static and published information stale.

### SUMMARY OF THE INVENTION

The technology described herein may be directed to a new and improved collaborative functionality associated with communications between two or more entities. The technology may, for example, enable, perform, or otherwise facilitate various data publication and subscription operations and activities. The data used or associated with various operations may include, but are not limited to, data derived from multiple sources as well as multiple data types. Further, various operations may include, for example, but are not limited to, provision of selectably filtered views of published data.

### BRIEF DESCRIPTION OF THE DRAWINGS

FIG. 1 illustrates an example of a computing system environment according to an embodiment of the invention;

FIG. 2 illustrates an example of a real time collaboration platform according to an embodiment of the invention;

FIG. 3 illustrates a set of program modules according to an embodiment of the invention;

FIG. 4 illustrates example data structures in table form, according to an embodiment of the invention;

FIG. 5 illustrates a flowchart of a data flow for a publish/subscribe session according to an embodiment of the invention;

FIG. 6 illustrates a flowchart of a method of real time publishing and subscribing according to an embodiment of the invention; and

FIG. 7 illustrates a method of communicating between an application and a data manager in a communication network having a real time endpoint and a remote endpoint according to an embodiment of the invention.

### DETAILED DESCRIPTION

Variations of the technology described herein may provide one or more services associated with a collaboration platform or collaborative activities. For example, such services may be associated with publication services for publishing data or subscription services for subscribing to published data. Other services may include, for example, update services for updating published items and notification services for notification of updates to published items. Various other services and functionality may be available, alone or in combination, as discussed herein.

Publication services may be associated with, for example, a publishing operation and/or a publish module. Such services or functionality may provide for publication of data derived from predefined lists of items; from various sources; from various types of data; or combinations thereof.

The functionality to receive a predefined list of items and to publish such data may include, for example, the receipt of lists of basic information. For example, such a list may contain a list of basic presence states, a description string, and an extension string.

The functionality to receive and to publish multiple data types may permit various sources to contribute in a meaningful way to the publication services as a whole. By way of illustration, and not of limitation, in an application describing the state of the entity publishing the information, the publishing functionality may facilitate receipt of various data types, such those that might be found in generic data structures. Such data types may include, for purposes of this example; “Presence” (indicating the status of a device); “GpsLocation” (indicating a location based on geographical coordinates); and “DeviceCapability” (indicating which capabilities may be attributable to a particular device). The publishing functionality may facilitate receipt and publication of the data related to each type. For example, the published data may indicate that a Presence item has a Presence status of “Online”; a GpsLocation item has properties of latitude equal to “47°38′N” and longitude equal to “122°23′W”; and so forth. The foregoing examples are illustrative only, and in no way limit the range or scope of publishing services or other services.

Subscription services may be associated with, for example, a subscribing operation or a subscription module. Such services or functionality may provide subscribers with unfiltered views of published data, filtered views of published data, or both.

The functionality to subscribe to unfiltered views of published data may permit subscribers to subscribe to and to receive published data in its entirety. In variations of this technology, the subscribers may electively receive such unfiltered views.

The functionality to subscribe to filtered views of published data may permit subscribers to subscribe to and to receive selected views of the published data. It may be possible to process one or more selected portions of a document and to selectively forego processing remaining portions of the document.

In this manner, it may be possible to improve the performance and the scalability of various subscriber applications that run on devices having differing processing capabilities. In variations of this technology, the subscribers may select the filtered view(s).

For example, the technology may facilitate processing of selected portions of a large XML document that contains the entire state published rather than expending the resources necessary to publish the entire document, including those portions of information in which the subscriber is not interested. For example, and with reference to a foregoing illustration, the subscriber may be interested in receiving only the GpsLocation. Thus, just the discrete information related to the GpsLocation may be provided, without burdening the devices, infrastructure, or users with processing and receiving unwanted information, such as the Presence data and the DeviceCapability data. The foregoing examples are illustrative only, and in no way limit the range or scope of subscribing services or other services.

The features and functionality may be broadly applied to various communication environments. For example, various aspects of the technology may be particularly applicable to single or multi-modal collaborative sessions between two or more entities, where timely, dynamic production and delivery of various types of information in real time are sought. Various implementations of the technology may also be applicable to other environments and activities; for example, control networks as well as broadcasting and/or listening activities.

Such functionality may be embodied, for example, in an application programming interface (API) or set thereof. The data may include, but is not limited to, for example, generic data structures. The technology may facilitate real time production, delivery, receipt, and update of unlimited, self-defining, and generic data structures (as well as predefined data structures). The data structures may include, for example, new types of structured data in the form of a common Object Oriented (OO) language construct such as an object class or an object instance.

The technology set out herein may be described in the general context of computer-executable instructions, such as program modules, executed by one or more computers or other devices. Generally, program modules include routines, programs, objects, components, data structures, and so forth that perform particular tasks or implement particular abstract data types. Typically the functionality of the program modules may be combined or distributed as desired in various embodiments. In a distributed computing environment, program modules may be located in both local and remote computer storage media, including memory storage devices.

Such computer-executable code, such as program modules, may be implemented on, or associated with, various computer readable media. Various computing devices typically include at least some form of computer readable media. Computer readable media can be any available media that can be accessed by such computing devices. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by such computing devices.

Communication media typically embody computer readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct wired connection, and wireless media such as acoustic, RF infrared, infrared, and other wireless media. Combinations of any of the above should also be included with the scope of computer readable media.

Turning now to the drawings, wherein like reference numerals refer to like elements, the technology is depicted implemented in a suitable computing environment. The computing environment is merely illustrative of one of various environments with which the technology may be associated and is not intended to suggest any limitation as to the scope of use or functionality of the technology. Various other well known computing systems, environments, devices and/or configurations may be suitable for use with the technology. Various environments include, but are not limited to, distributed computing environments such as a communication network or networks. Such communications networks may include, for example, various remote processing devices, nodes, and/or entities linked by the network.

Examples of well known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like. Program modules, for example, may be physically located and/or logically associated with one or more such devices.

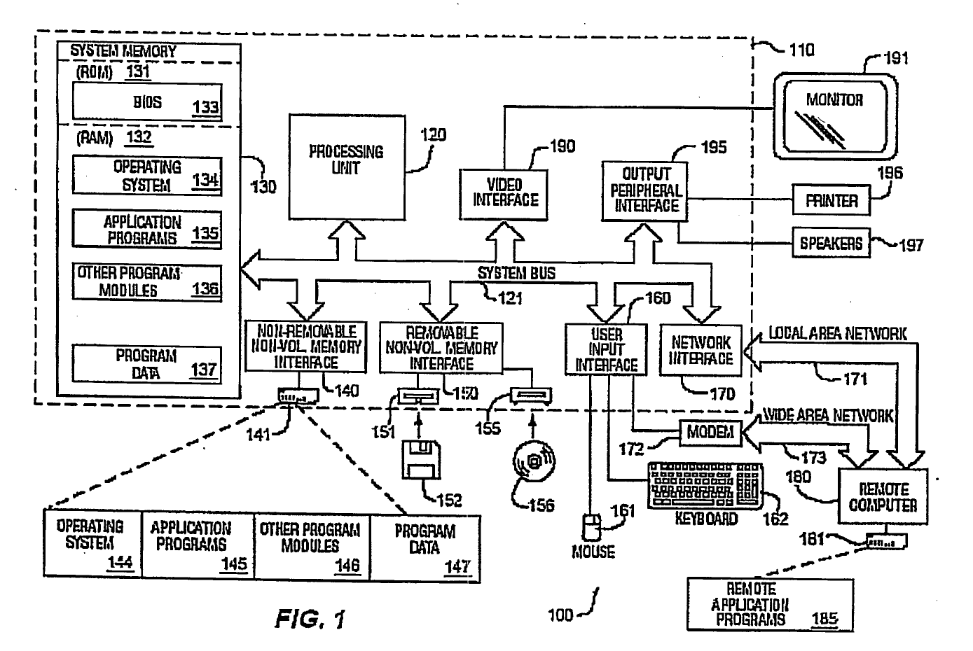

With reference to FIG. 1, there is shown generally a suitable computing system environment 100 on which the technology may be implemented. The computing system environment 100 is only one example of a suitable computing environment and is not intended to suggest any limitation as to the scope of use or functionality of the technology. Neither should the computing environment 100 be interpreted as having any dependency or requirement relating to any one or combination of components illustrated in the exemplary operating environment 100.

The exemplary computing system environment 100 may include, for example, a general purpose computing device in the form of a computer 110. Components of the computer 110 may include, but are not limited to, a processing unit 120, system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) local, and Peripheral Component Interconnect (PCI) bus, also known as Mezzanine bus.

The computer 110 typically includes a variety of computer readable media Computer readable media can be any available media that can be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during startup, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

As introduced above, the technology may be associated with, for example, real time collaboration activities. Real time collaboration may be generally defined as involvement with some form of communication activity between two or more entities, each entity having a unique identity. By way of example, and not of limitation, entities may be associated with the notion of a user. The term “user” is not restricted to a real person, but includes, for example, any entity associated with a collaborative activity, such as, for example, an automated device. A user may create an endpoint to enable the user to communicate with other users. The services and functionality of the technology may be exposed by a real time endpoint. A real time endpoint may identify an addressable entity associated with an identity in the context of a service and may provide, for example, real time publishing, updating, delivery, subscription, and notification services for one or more entities. For example, in various aspects of the technology, each real time endpoint may be identified by a unique Universal Resource Identifier (URI) and by an endpoint identifier (ID). The real time endpoint may provide the “local” context for all collaboration primitives. It is contemplated that the real time endpoint may be associated with various environments, including server-centric communication networks as well as serverless communication networks.

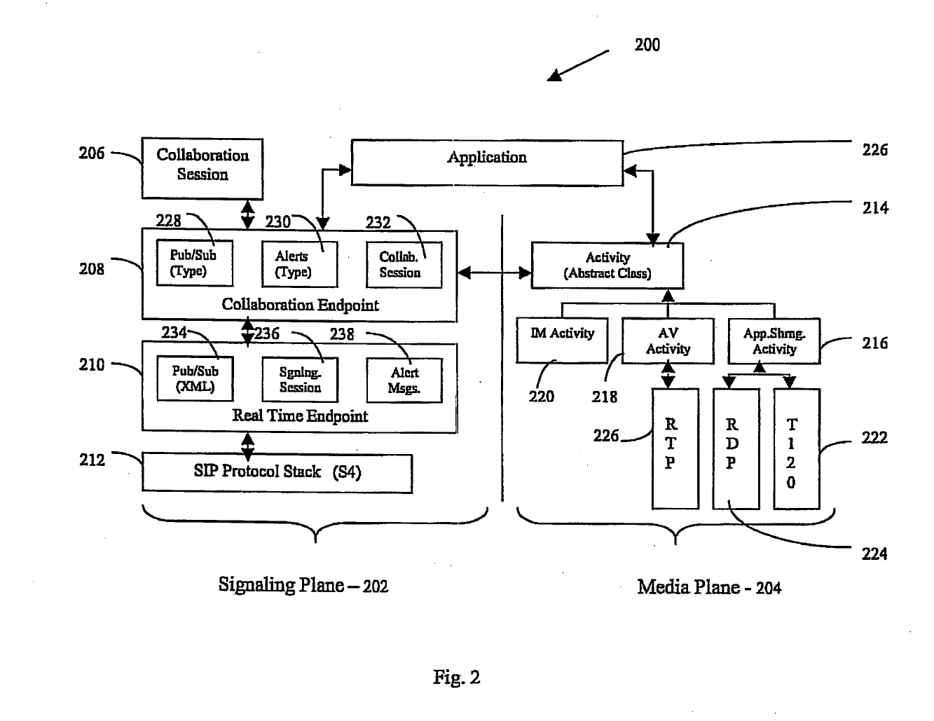

With reference now to FIG. 2, the general architecture of a real time collaboration platform 200 is shown. The illustrative real time collaboration platform 200 may be associated with, for example, a signaling plane 202 and a media plane 204. The signaling plane 202 may include, for example, a collaboration service module 206, a collaboration endpoint 208, the real time endpoint 210, and a Session Initiation Protocol (SIP) protocol stack 212. The media plane 204 may include, for example, one or more activities 214 (represented here as an abstract class); various activities such as an application sharing activity 216; an audio/video (AV) activity 218; and an instant messaging (IM) activity 220. The activities may be associated with one or more protocols, for example, T120 222; Remote Desktop Protocol (RDP) 224; or Real-Time Transport Protocol (RTP) 226.

An endpoint, such as the collaboration endpoint 208 or the real time endpoint 210, may publish data to which other endpoints may subscribe. The data may be of any type that is defined by, for example, a platform API or defined by an application 226 itself. If there is server backing available to support the endpoint, the data published by the endpoint might persist at the server (not shown) and thus be available for subscription even after the endpoint is unregistered, such as where the registration of the endpoint is terminated. Such data is termed herein as “per-URI data” (not shown). An endpoint may also publish data having a lifetime that approximates that of the publishing endpoint, i.e., “per-endpoint data” (not shown). Per-endpoint data typically may not be available once the endpoint is unregistered or terminated. The real time collaboration platform 200, and the collaboration endpoint 208 may support, inter alia, a type-based publish/subscribe module 228 in which the application 226 may specify the type of item to be published or subscribed; a type-based alerts module 230 for handling type based alerts; and a collaboration session module 232 for handling multiple activities between two or more endpoints in the context of a single session.

Sessions, such as a signaling session, may provide a control plane needed for two endpoints to invite an activity and exchange media descriptions that may be required to establish media communication. The session is generally helpful for exchange of short control messages as well as text messages between endpoints.

Media stacks (not shown) may provide specific APIs for handling various data streams. These APIs may deal exclusively with the data channel; i.e., sending and receiving various media data, while the signaling functionality may provide the control channel.

Activities 214 may provide a higher abstraction that solidifies the signaling channels and media channels into an easy-to-use API. The activities 214 may provide aggregated components that encapsulate the steps required to use the factored components exposed by the signaling plane 202 and the media plane 204. The real time collaboration platform 200 may provide some standard set of activities as well as the custom activities built by the application 226.

The collaboration service module 206 may provide for very high-level applications that seek collaboration features at a very high level. For example, the application 226 may want to start an instant messaging session, yet may not want to host the user interface (UI) for the session itself. The collaboration service module 206 may support the application level API exposed by the messenger service for existing applications 226.

The collaboration endpoint 208 may, in various aspects of the technology, interact with the real time endpoint 210, which may provide various services and functionality such as publishing and subscribing via its publishing and subscribing module 234; signaling via its signaling session module 236; and alert messaging via its alert message module 238. The publishing and subscribing services may be based on a markup language, such as an Extensible Markup Language (XML). The real time endpoint 210 may, in turn, interact with low-level stacks such as the SIP protocol stack 212.

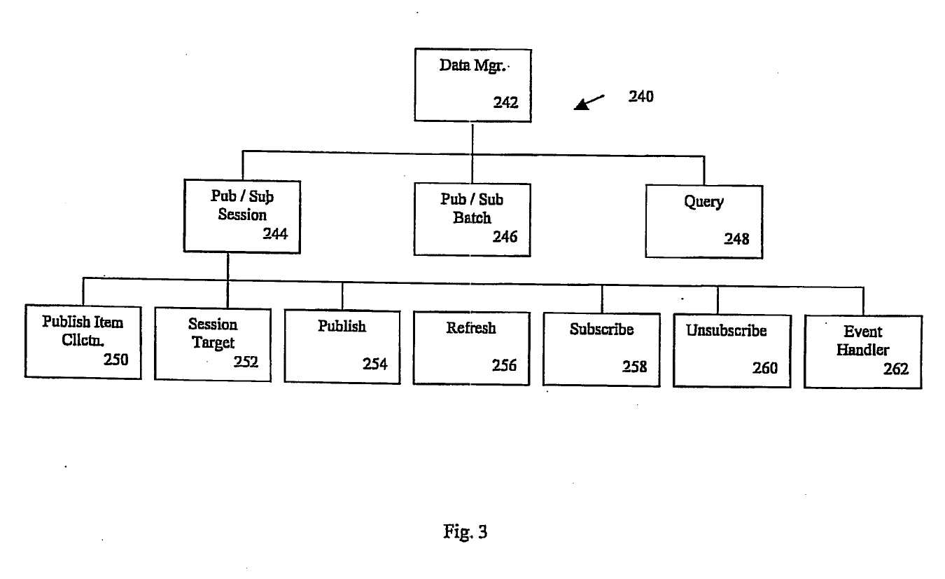

With continuing reference to FIG. 2 and with reference to FIG. 3, there is shown a set of modules for publishing and subscribing 240, which may include, for example, a data manager module 242; a publish/subscribe session module 244; a publish/subscribe batch module 246; and a query module 248. A skilled artisan will appreciate that the functionality exposed by such modules may be embodied in various other structures, methods, and configurations, so long as the functionality described herein is carried out.

The data manager module 242 may call one or more modules in various combinations to provide various services. For example, the data manager module 242 may call the publish/subscribe session module 244 to create a session between a local real time endpoint 210 and a remote endpoint; for publishing data on behalf of the local real time endpoint 210; and for subscribing to data published by the remote endpoint. The data manager module 242 may call the publish subscribe batch module 246 to create a batch session for all specified target URIs or remote endpoints; and/or may call the query module 248 to query data for the target URI or remote endpoint.

The publish/subscribe session module 244 may, for example, allow the application 226 to create a publish/subscribe session for data published by the identified entity. A generic type parameter may be used to specify the type of published items that the session will contain while a target parameter may be used to specify the target of the session (the entity to which the real time endpoint 210 is subscribing, for example). The target may represent, for example, either the URI or a URI in combination with an endpoint ID. Various aspects of the technology may enable delegation for publishing by allowing the target URI of the session to be different from the URI of the real time endpoint providing the local context. This may be possible, for example, if the target entity has published an access control enabling the local entity to publish items on behalf of the target entity. An illustrative scenario in which this might be useful may be drawn to an assistant publishing calendar items for a manager.

The publish/subscribe session module 244 may call various modules to accomplish the above-described functionality. These modules may include one or more of the following: a publish item collection module 250; a session target module 252; a publish module 254; a refresh module 256; a subscribe module 258; an unsubscribe module 260; and an event handler module 262.

The published item collection module 250 may, for example, get a list of published items in the present session. The items may represent a live collection of items of the specified type. The published item collection module 250 may support such events, for example, as add, remove, and clear functions that occur in the list. The list may initially be empty until the subscribe module 258 is called. If the application 226 adds items to this collection and calls the publish module 254, the collection may only contain, for example, the items published. To get all the items published by the target URI, the application may also call the subscribe module 258. It should be noted that the same session may be used to both subscribe to item changes as well as to publish new items or item updates.

The session target module 252 may procure a target of the current subscription.

The publish module 254 may, for example, synchronously or asynchronously publish updates to the current session, thus allowing an application to make changes to session items (which may represent a local cached copy) and then may commit these changes to the backend storage, making these changes visible to all subscribers.

The refresh module 256 may synchronously or asynchronously refresh session items, bringing the session items in synchronization with the backend storage. After refreshing, all unpublished updates to the session may be lost, at which point, the session may contain the most current set of published items. This may be useful, for example, if the application 226 seeks to discard all changes made to the session items, or if the application 226 needs to recover from a failed publish operation.

The subscribe module 258 may synchronously or asynchronously start a subscription for items session, enabling the session to receive notifications of item changes. Any errors occurring after the session is started may be reported through the event handler module 262. After the operation completes, the session may receive notifications for item changes. The subscription may remain active until the session is unsubscribed. A subscriber may elect to receive, and to receive, one or more filtered views of the published data.

The unsubscribe module 260 may, for example, synchronously or asynchronously terminate a subscription for item updates in the current session.

The event handler module 262 may be used to handle errors occurring in the session. For example, the event handler module 262 may be used when an error resulting in session disablement occurs while the session is active. Some examples of such an error include transport errors, subscription refresh errors, and server notification errors.

The publish/subscribe batch module 246 may be used to allow the application 226 to create batch sessions for a specific item type. A generic type argument may be used to designate the type of published items in which the application is interested, while a targets parameter may be used to specify a list of session targets to which the application 226 subscribes. Batch sessions may be convenient, for example, if the application requires several sessions of the same type and may also provide the platform to optimize the network traffic when possible.

The query module 248 may be used to allow the application 226 to retrieve a one-time snapshot of the published data for the specified target. The query module 248 may return a collection of published items at the time of the query. Similar to the publish/subscribe session module 244, the target may either specify a URI to query the entity data or a URI-endpoint pair to query a specific endpoint for its data. The query module 248 may be desirable, for example, when a session lasting in duration only as long as needed to complete a one-time, fast request is desired, as opposed to a long-lived, slower session having, for example, multiple activities and events occurring over a relatively longer period of time.

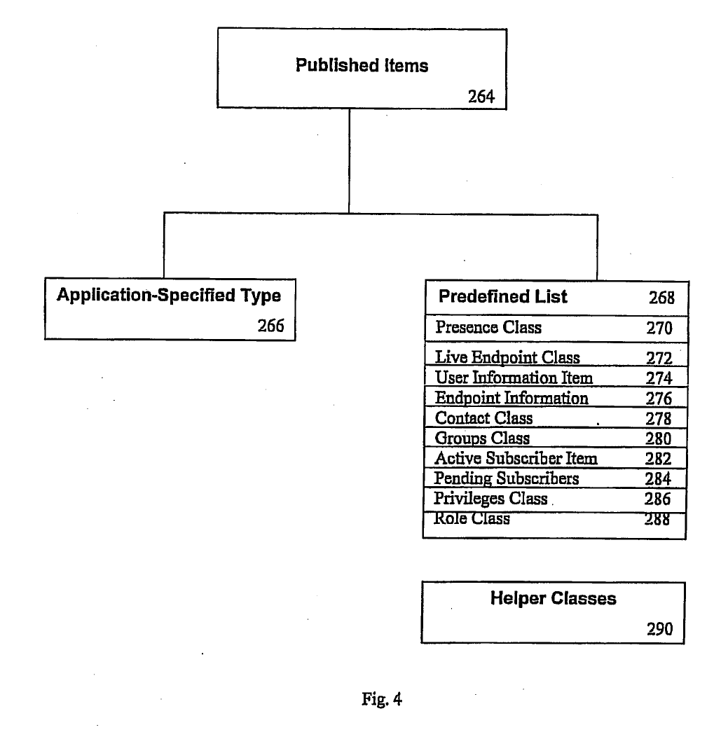

With continuing reference to FIGS. 2 and 3, and with reference to FIG. 4, various aspects of the technology may contain elements called published items, shown generally at 264. When creating a publish/subscribe session, the application 226 may specify the type of published items of interest (application-specified type) 266 and as a result, the session might only contain items of that type. In various aspects of the technology, a predefined list 268 of published items of general use may be supported by default. For example, the predefined list 268 may include one or more of the following: a presence class 270 to allow applications to publish and/or subscribe to the simple presence state of an entity; a live endpoint class 272 to define an item that provides information about an active endpoint of a publisher; a user information item 274 to allow an application to publish and/or subscribe to user-specific data; endpoint information 276 to allow an application to publish local endpoint information; a contact class 278 to define a publishable item used to describe a signaling/subscription contact of the current publisher; a groups class 280 to allow an application to classify contacts based on a commonality; for example, the relationship with the contact publisher; an active subscriber item 282 to allow an application developer to obtain a list of subscribers currently maintaining an active subscription for the items published by the entity associated with the current endpoint; a pending subscribers class 284, or entities that have attempted to subscribe to the data published by the entity associated with the current endpoint, but were given an access prompt; a privileges class 286 that allows an application to associate access rules with various real time resources; and a role class 288 that allows applications to group principals with the same access level into groups for easier management of permissions associated with various real time resources.

Publishable items may allow applications to make available various pieces of information to different subscribers in the context of a publishing session. Since the publishing state of the item may vary; i.e., whether the latest changes of the item are published or not, various aspects of the technology may not allow the same item instance to be published in different sessions at the same time, as attempting to add the same item instance to two different session instances may result in throwing an exception.

Applications may make changes to items published in publish/subscribe sessions and call the publish module 254 of the session to make the updates visible to all subscribers.

A requires publishing flag (not shown) may indicate that something changed since the last update and hence the changed item may require publishing. The requires publishing flag may be reset after the nublish operation is complete unless, for example, there are further updates after the snapshot was taken for publishing.

Serialization (reading an object into a byte stream) and deserialization (reconstructing the stream into an existing object instance) may be employed in various aspects of the technology. In aspects of the technology utilizing serialization, types may be typically marked as “serializable”, and may have a default empty constructor defined. Various aspects of the technology may utilize an extensible markup language (such as XML, for example) in conjunction with, or independent from, various serialization processes. In various aspects of the technology, deserialization into an existing object instance may be employed and may be handled by the published item itself via various methods.

Various aspects of the technology may include helper classes 290, or classes that aggregate multiple sessions and understand and maintain relationships between items published in such sessions. In this manner, referential integrity may be ensured.

The real time endpoint 210 may receive a type-based data structure from, for example, the collaboration endpoint 208 or other source and may send an extensible data structure to, for example, the collaboration endpoint 208 or other destination.

In various aspects of the technology, the real time endpoint 210 may be associated with a server-based (server-centric) network. In such a scheme, various configurations of the server may be utilized. For example, the server may be configured through Domain Name System (DNS) records or the application 226 may supply a specific server to be used in the session or activity. The application 226 may specify the real time endpoint name using, for example, a name that meaningfully identifies the real time endpoint 210. The endpoint ID may be auto-generated by the real time endpoint 210 itself to guarantee uniqueness. The application 226 may specify authentication protocols and a set of credentials to be used for various realms. When the application 226 indicates the specific server, the application 226 may also supply the transport type to be used for the connection to the server.

The server endpoint may establish a connection with the server, which may act as a registration server as well as a proxy. Once the real time endpoint 210 is created, the application 226 may register with the server to allow the server to route messages to this real time endpoint 210. The server may challenge the real time endpoint 210 and the challenge may typically contain the realm used by the server. To answer the challenge, the application 226 may be required to supply credentials. The real time endpoint 210 may expose a class that maintains a list of credentials. The application 226 may add a credential to this class for a specific realm or add a default credential that may be used for all realms. In various aspects, the API may not support Basic or Digest authentication and thus the default mechanism may be safe to use. The credential may indicate the use of logged-on credentials.

Once the registration is successful, the real time endpoint 210 may be ready to receive messages from others, provided proper access controls (not shown) set by the real time endpoint 210 are satisfied. Without registration, the endpoint 210 may not receive messages from other endpoints; however, some servers might allow the real time endpoint 210 to send outgoing messages without actually registering. Similar to a registration message, these messages may also be challenged by the server. Some servers may require the real time endpoint 210 to be registered to deliver incoming invitations or other messages.

When no server is available, real time endpoints 210 may communicate directly with other similar real time endpoints 210 in a serverless, or peer-to-peer, configuration. In various aspects of the technology, the real time endpoint 210 may, for example, receive messages only if listening is enabled. By default and for security reasons, the real time endpoint 210 does not listen and thus may be only capable of sending outgoing messages; and, in some aspects of the technology, may be incapable of receiving messages.

For creation of a serverless real time endpoint 210, the application 226 may not need to specify a URI. Depending on how the application 226 calls the start listening module, there may be zero or more listening addresses. Any one of these addresses may be used as the URI for the real time endpoint 210 and the selection of one may depend on the target URI that needs to contact this real time endpoint 210.

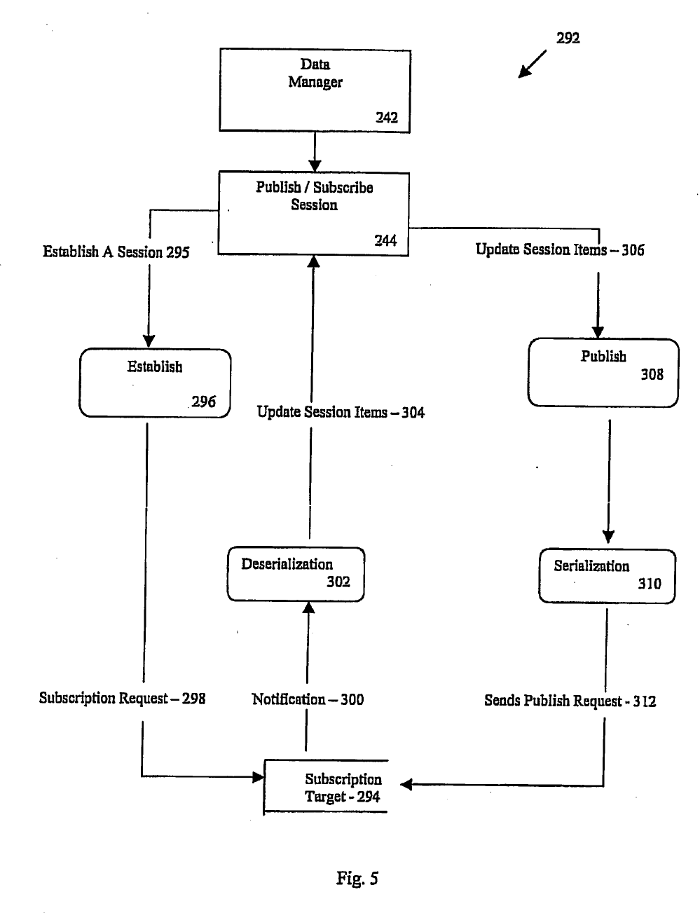

With continuing reference to FIGS. 2-4, and with reference to FIG. 5, there is illustrated a flowchart for the data flow of a publish/subscribe session at 292.

If, for example, the application 226 is interested in subscribing to data published by a remote endpoint such as a subscription target 294, the application 226 may use, for example, the data manager module 242 associated with the local real time endpoint 210. The data manager module 242 may create a session via the publish/subscribe session module 244. The application 226 may, for example, establish a subscription at 295 via the establish module 296, which may generate a subscription request at 298 to the subscription target 294. The subscription target 294 may send notification at 300 of updated session items, which may be deserialized via the deserialization module 302, updating such items at 304, which may be passed back to the publish/subscribe session module 244. The publish/subscribe session module 244 may update session items at 306, sending such items to the publish module 308, whereafter the serialization module 310 serializes the items, and sends a publish request at 312 to the subscription target 294. In variations of the technology, selectably filtered views of the published data may be provided.

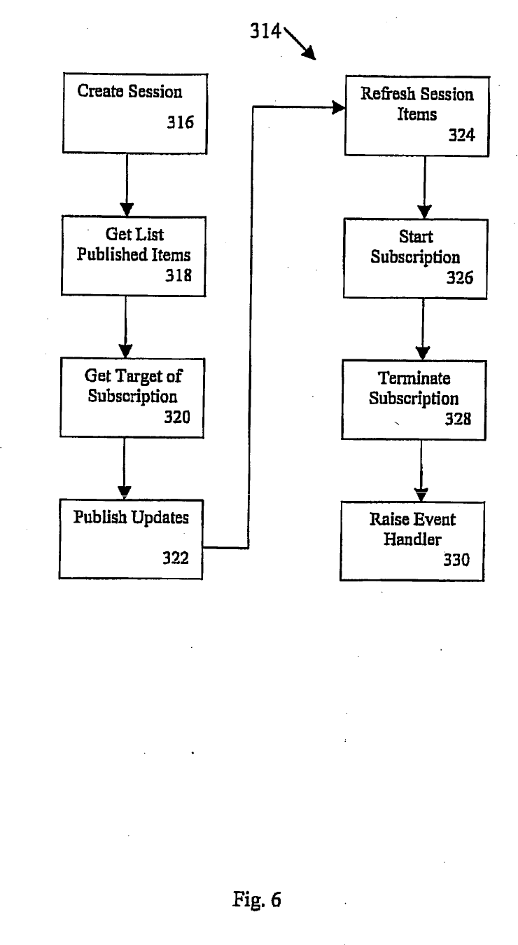

With reference now to FIG. 6, there is shown generally at 314 an implementation of real time publishing and subscribing. The implementation 314 may include one or more of the following steps: creating a session at 316; getting a list of published items present in the session at 318; getting a target of the subscription at 320; publishing updates to the session at 322; refreshing the sessions items at 324; starting a subscription for items session at 326; terminating a subscription for item updates at 328; and raising an event handler when an error occurs in the session at 330.

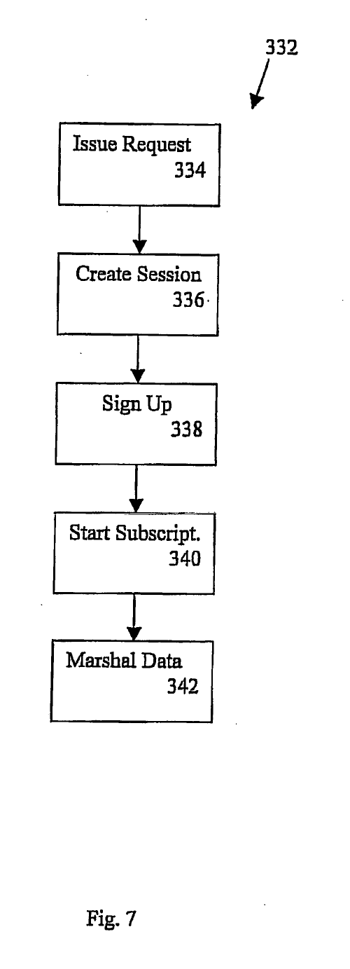

Turning now to FIG. 7, there is shown an implementation of communicating 332 between an application and a data manager in a communication network having a real time endpoint and a remote endpoint. The communication 332 may, for example, include steps of issuing, by the application associated with the real time endpoint, a request to the data manager to subscribe to data published by the remote endpoint at 334; creating, by the data manager, a publish/subscribe session between the real time endpoint and the remote endpoint at 336; signing up, by the data manager, for receiving events in the session at 338; starting, by the data manager, a subscription at 340; and marshaling, by the data manager, data between the application and the remote endpoint at 342.

It should be noted that the foregoing relates to various embodiments of the technology and that modifications may be made without departing from the spirit and scope of the technology as set forth in the following claims.

What is claimed is:

1. A computer-readable medium having computer-executable modules comprising:
a publish/subscribe session module for creating at least one session between a real time endpoint and a remote endpoint; for receiving data of at least one type of multiple data types; and for publishing data of at least one type of multiple data types.

2. The computer-readable medium of claim 1, wherein the publish/subscribe session module further operates to subscribe to data published by the remote endpoint.

3. The computer-readable medium of claim 1, further comprising a subscribe batch module for creating batch sessions.

4. The computer-readable medium of claim 1, further comprising a query module for querying data for the at least one remote endpoint.

5. The computer-readable medium of claim 1, further comprising:
a published item collection module for getting a list of published items in a current session;
a session target module for procuring a target of the current session;
a publish module for publishing updates to the current session;
a refresh module for refreshing session items;
a subscribe module for starting a subscription for items session;
an unsubscribe module for terminating a subscription for item updates in the current session; or
an event handler module for handling errors occurring in the current session.

6. The computer-readable medium of claim 1, wherein the real time endpoint and the at least one remote endpoint are associated with a server-centric network.

7. The computer-readable medium of claim 6, further comprising per-URI data associated with the publishing and subscribing operations.

8. The computer-readable medium of claim 1, wherein the real time endpoint and the remote endpoint are associated with a serverless network.

9. The computer-readable medium of claim 8, further comprising per-endpoint data associated with the publish/subscribe session module.

10. A method of providing collaborative services, the method comprising steps of:
creating a publish/subscribe session associated with a real time endpoint;
generating a subscription request to a subscription target;
receiving notification of session items to be updated;
updating the session items; and
providing at least one filtered view of the updated session items, based on at least one data type.

11. The method of claim 10, further comprising a step of publishing data on behalf of the real time endpoint.

12. The method of claim 10, further comprising a step of using a markup language.

13. The method of claim 10, further comprising a step of deserializing the session items to be updated.

14. The method of claim 10, further comprising a step of serializing deserialized items.

15. A computer-readable medium having computer-readable instructions for performing steps recited in claim 10.

16. A method of communicating between a client process and a server process in a communication network having a real time endpoint, the method comprising steps of:
receiving a request to subscribe to data published by a remote endpoint;
creating a publish/subscribe session between the real time endpoint and the remote endpoint, the publish/subscribe session being created based on one or more data types selected from a set of data types;
enabling receipt of events in the publish/subscribe session; and
marshaling data to the client process, wherein the data comprises at least one filtered view.

17. The method of claim 16, further comprising publishing updates to session items.

18. The method of claim 16, wherein the filtered view is based on one or more data types.

19. The method of claim 16, wherein the data includes a predefined list of items.

20. The method of claim 19, wherein the predefined list of items comprises:
a presence class;
a live endpoint class;
a user information item;
endpoint information;
a contact class;
a groups class;
an active subscriber item;
a pending subscribers class;
a privileges class; or
a role class.
